(19) United States
(12) Patent Application Publication
(10) Pub. No.: US 2008/0181706 A1
(43) Pub. Date: Jul. 31, 2008

(54) Tactile Force Sensor and Hybrid Stenotype Keyboards and Method of Use

(76) Inventor: Johnny J. Jackson, Charleston, WV (US)

Correspondence Address: THOMPSON HINE L.L.P.;Intellectual Property Group, P.O. BOX 8801, DAYTON, OH, 45401-8801, US

(21) Appl. No.: 12/020,340

(22) Filed: Jan. 25, 2008

Related U.S. Application Data
(60) Provisional application No. 60/886,572, filed on Jan. 25, 2007.

(51) Int. Cl. B41J 5/00

(52) U.S. Cl. 400/482

(57) ABSTRACT

A stenotype keyboard utilizes pressure sensitive tactile sensors to register key presses and output interpreted keystrokes. The pressure sensitive tactile sensors are illuminated internally and create detectible changes to the electromagnetic radiation when compressed. The detectible changes are picked up by sensors and analyzed to determine which keys are pressed and the appropriate keystrokes are generated. Keystrokes are then either output or stored in memory for later retrieval. The pressure sensitive tactile sensors facilitate creating keyboard configurations such as combination hybrid keyboards that have both computer style layouts and stenotype keyboard layouts.

### CROSS-REFERENCE TO RELATED APPLICATIONS

This application claims the benefit of U.S. provisional Application Ser. No. 60/886,572, entitled, “Tactile Force Sensor and Hybrid Stenotype Keyboards and Methods of Use”, filed on Jan. 25, 2007.

### BACKGROUND OF THE INVENTION

Stenography is a well-established method for real-time translation of verbal communications into written words. Stenography is commonly used for court reporting as well as for any time close-captioning is required because it results in faster, more accurate, translation of words to type than other methods. Stenography utilizes a shortcut notation system combined with a stenotype machine that has a characteristic keyboard layout, which is well known in the art, and allows specially trained stenographers to input whole words at once with a simultaneous push of one or more keys. By comparison, typing on a manual typewriter or computer keyboard requires each letter of a word to be individually typed, resulting in multiple keystrokes for each word. Because trained stenographers input whole words at a time, they often reach speech-to-text speeds of 300 words per minute, which is more than adequate to record real-time speech and 3-4 times the rate that people are generally capable of typing on typewriters or computers.

Besides having a particularized layout, a stenography machine also functions differently than a normal keyboard in that multiple keys are simultaneously depressed in normal operation to form syllable of a word, a complete word itself, or a shorthand representation of a word or phrase. Certain key combinations are routinely depressed by the same finger at the same time, for example the T and K; P and W; and H and R keys. A stenographer does this by pressing a finger approximately at the crack between the two keys which are situated one above the other, and pressing both keys simultaneously. Stenography machines are designed to allow and facilitate two keys to be pressed together by a single finger by purposefully placing the two keys in very close proximity to one another and coordinating the mechanical travel of both keys together such that even a somewhat mis-positioned finger still successfully depresses both keys together. A stenography machine requires the stenographer to depress far fewer keys than on a normal computer keyboard in order to transcribe spoken words.

Standard computer keyboards, however, are less forgiving, and are purposefully designed such that each finger normally only depresses a single key at a time. Each key in a computer keyboard typically has a single stem with a return spring under each key. The stem makes each key optimally depressed only in the vertical direction and impedes to some degree any lateral travel of neighboring keys that might register inadvertently as a keystroke, thus preventing accidental registering of two simultaneous keystrokes by a single push of a finger. The keys themselves are offset slightly from one another and shaped in such a way that there are gaps between adjacent keys, further inhibiting the accidental pushing of two keys simultaneously by a single finger. Additionally, the rows of keys on a computer keyboard are still staggered vertically just as they originally were on early purely mechanical typewriters that required staggering for mechanical reasons. A typical computer keyboard therefore has a much different layout and tactile response than a stenotype keyboard.

Because a stenograph uses fewer keys, there are a sufficient number of keys on a typical computer keyboard to remap a stenograph layout onto the computer keyboard's keys. The patent application “Modal Computer Keyboard Stenography Emulation Apparatus and Method”, publication no. US 2002.0150416 to VanDruff, describes such a remapping of stenograph keys to a traditional computer keyboard. However, simply remapping the stenograph machine's keyboard layout to a computer keyboard does not provide a stenographer with the right layout and tactile response necessary to properly use the computer keyboard as a stenography keypad. The patent “Quasi-Steno Keyboard for Text Entry into a Computer”, patent no. Re. 34,304 to Goldwasser et al., is a combination stenotype and computer keyboard that attempts to overcome this problem by reshaping and elongating keys in combination with making some of the stenotype keys coplanar with one another instead of using the traditional staggered vertical layout of a computer keyboard.

While Goldwasser et al. compensates for the layout differences to a degree, it is a modified computer keyboard and therefore has a different tactile response than a stenograph. Goldwasser et al. requires a stenographer, when pressing two keys simultaneously, to depress both keyboard keys just as they would for a traditional computer keyboard in order to register both keystrokes. A computer keyboard, however, has somewhat different key travel than a stenotype keyboard and anatomically, a finger has a more rigid top portion due to the nail and bony structure, whereas the bottom has padding and therefore compresses more easily. Due to the design of computer keys and the finger's anatomy, the keyboard in Goldwasser et al. is susceptible to missing a bottom key press when a user attempts to simultaneously press a top and bottom key together. Therefore, there is a need for a keyboard that can be used as both a computer keyboard and a stenotype keyboard that has the tactile response of a stenography keyboard while being suitable for use as a computer keyboard.

Modern stenographers often have computers assist in the transcription of their stenographic-encoded keystrokes back into user-readable text. These computers perform both straight substitutions as well as detailed post-processing of transcribed sentences to ensure accuracy. Computers also allow stenographers to develop libraries of individualized shorthand expressions to further reduce the number of keystrokes necessary for the stenographer, especially for commonly repeated words or phrases. Because space is usually a concern, stenographers typically use laptop computers But even with a laptop, the stenographer still has to physically move from the stenograph machine to the laptop keyboard.

There are also times when it would be advantageous for stenographers, such as court reporters, to use a standard keyboard instead of a stenography machine. Stenography relies on using phonetic shortcuts instead of correctly spelling words which works well in transcribing repetitive everyday common words that are part of normal speech. But when transcribing proper words, such as names and addresses, it could be beneficial for the stenographer to be able to spell these proper words correctly in the transcript, instead of relying on memory or retranslation of a phonetic transcription. Similarly, numbers are somewhat more difficult to enter on a stenotype machine because numbers are order specific, thus necessitating the use of one number per line on stenography machines. However, during a courtroom session there is usually insufficient time for a stenographer to physically switch from one input device to another. Therefore, there is a need for an apparatus, system and method that can allow a stenographer to quickly switch between using a keyboard as a normal computer style input means and using it as a stenotype style input means without physically having to move from one physical input device to another.

Stenography machines are expensive and heavy. Stenography machines are well suited for a courtroom environment, where there is sufficient space and a permanent dedicated place for a court reporter. However, there are some environments that are ill-suited for stenography. Depositions, for example, often occur in less formal environments, such as cramped conference rooms, making it more challenging for a stenographer to find a comfortable place for placing the stenograph where there is also access to a power plug. Finding additional space for a separate computer keyboard further adds to the difficulty. Also, because stenography machines are heavy, they must be lugged to and from the deposition, adding costly setup and teardown time, and due to their weight they are not capable of being used in the stenographer's lap which could be advantageous when space is tight. Therefore, there is a need for an apparatus that is an inexpensive, lightweight stenography keypad that can be easily transported, set up, and used in a small footprint, for example on a stenographer's lap.

The apparatuses, system, and method described herein address these problems and others.

### SUMMARY

The following summary is intended to provide a simple overview as well as to provide a basic understanding of the subject matter described herein. It is not intended to describe or limit the scope of the claimed subject matter. Furthermore, this summary is not intended to describe critical or key elements of the claimed subject matter. Additional aspects and embodiments are described below in the detailed description.

The subject matter described herein is directed to an apparatus for a stenotype keyboard that uses novel materials to create a keyboard that is lightweight and easy to transport while still providing proper tactile keyboard response to stenographer key presses. In one embodiment, the apparatus, system and method for a hybrid stenotype keyboard unit uses a specially designed combination stenograph and computer keyboard with a layout that allows the keyboard to function as both a stenographer keyboard or computer keyboard. The apparatuses, system, and method are especially applicable for courtroom and deposition stenography, but are also generally applicable to other types of speech-to-text transcription services.

### BRIEF DESCRIPTION OF THE DRAWINGS

The claimed subject matter is described with reference to the accompanying drawings. In the drawings, like reference numbers indicate identical or functionally similar elements. Additionally, the left-most digit(s) of a reference number identifies the drawing in which the reference number first appears.

FIG. 1 is diagram of a prior art stenographic keyboard layout.

FIGS. 2a and 2b are diagrams of prior art Qwerty and Dvorak computer keyboard layouts, respectively.

FIG. 3 is a diagram of an embodiment of a tactile force sensor stenotype keyboard in accordance with an aspect of the subject matter described herein.

FIGS. 4a, 4b, 4c, and 4d are cross sections of various embodiments of tactile force sensors used as sensing areas of a keyboard in accordance with an aspect of the subject matter described herein.

FIG. 5 is an embodiment of a hybrid stenotype keyboard in accordance with an aspect of the subject matter described herein.

### DETAILED DESCRIPTION

As described above stenographers are often required to work in imperfect environments to perform stenography for their clients. Carrying a heavy traditional stenography machine to a client's facilities can be burdensome and client facilities may create obstacles to using traditional stenography machines. Stenographers typically use stenographs in conjunction with laptop computers for instantaneous transcription into plain text, and there are times during transcribing when using a standard computer keyboard could be helpful to a stenographer. Even stenographers who are well accommodated in courtroom settings often have space issues and time constraints that inhibit quickly moving from a stenograph to a laptop. A novel stenotype keyboard is presented to address these and other problems.

### PRIOR ART

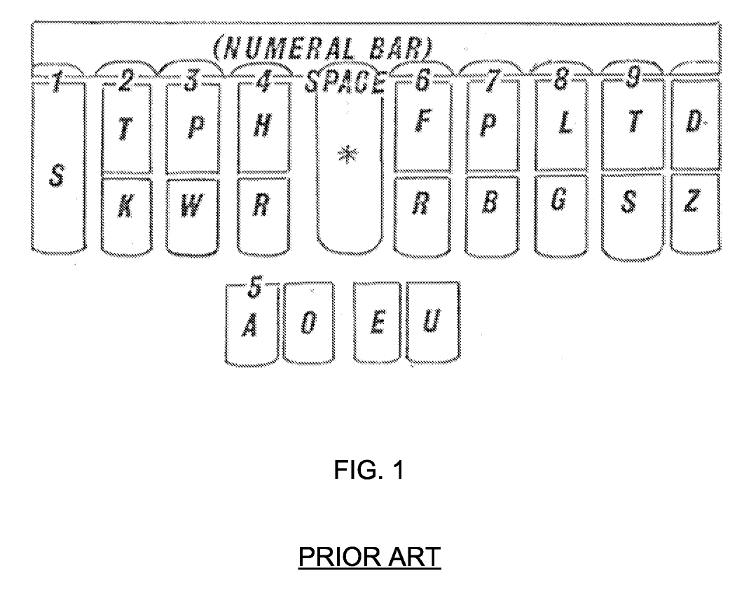

Turning now to FIG. 1, a prior art stenographic keyboard is illustrated. Unlike traditional keyboard typing where each letter of a word is individually transcribed by striking a key matching each letter, stenography is performed by phonetically typing an entire syllable of a word, a word itself, or a shorthand representation of a word or phrase. A stenographer transcribes by depressing multiple keys at a time to represent syllables, words, and phrases. A stenographic keyboard does not have a separate key for each of the 26 letters of the alphabet, and instead has a completely different layout where several letters are repeated on the keyboard, for example there are two S and two T keys, while other letters are missing altogether, for example I, M, and N. Trained stenographers use keys by themselves and in combinations to transcribe the various syllables, words, and phrases.

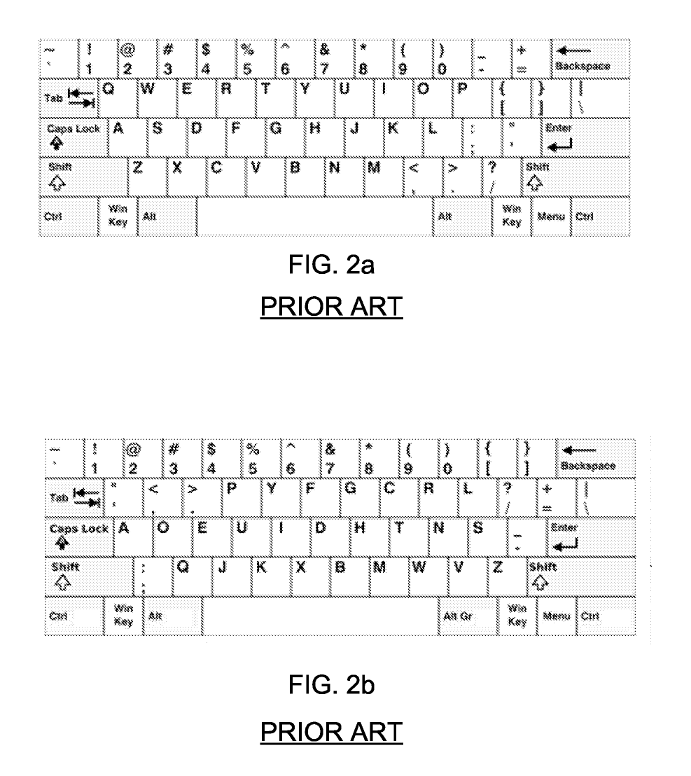

Referring now to FIGS. 2a and 2b, prior art computer keyboards are illustrated. A computer keyboard has a key for each of the 26 letters of the alphabet. The typical layout for a computer is the Qwerty layout as shown in FIG. 2a although alternative layouts such as Dvorak layout also exist as shown in FIG. 2b.

As FIGS. 1, 2a and 2b illustrate, the stenotype keypad uses far fewer keys and a different key layout than a computer keypad.

Stenotype Keyboard with Tactile Force Sensors

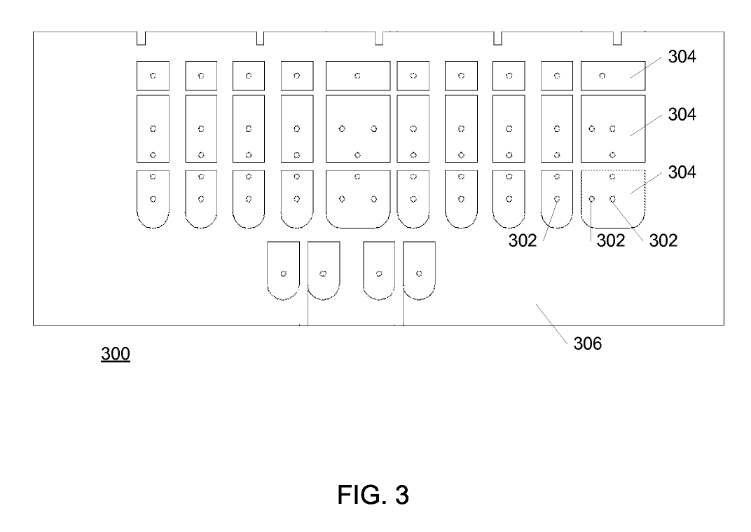

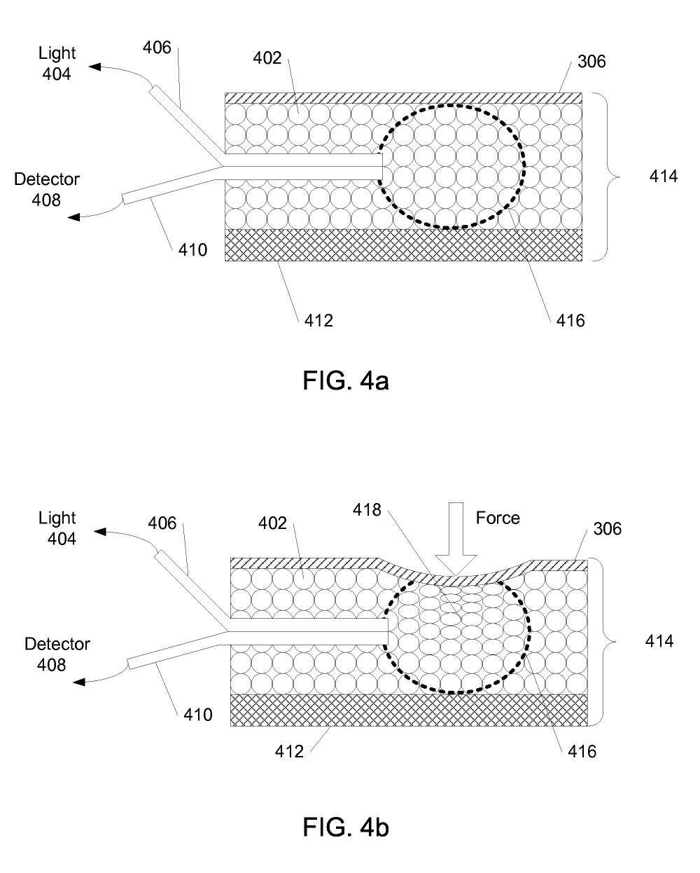

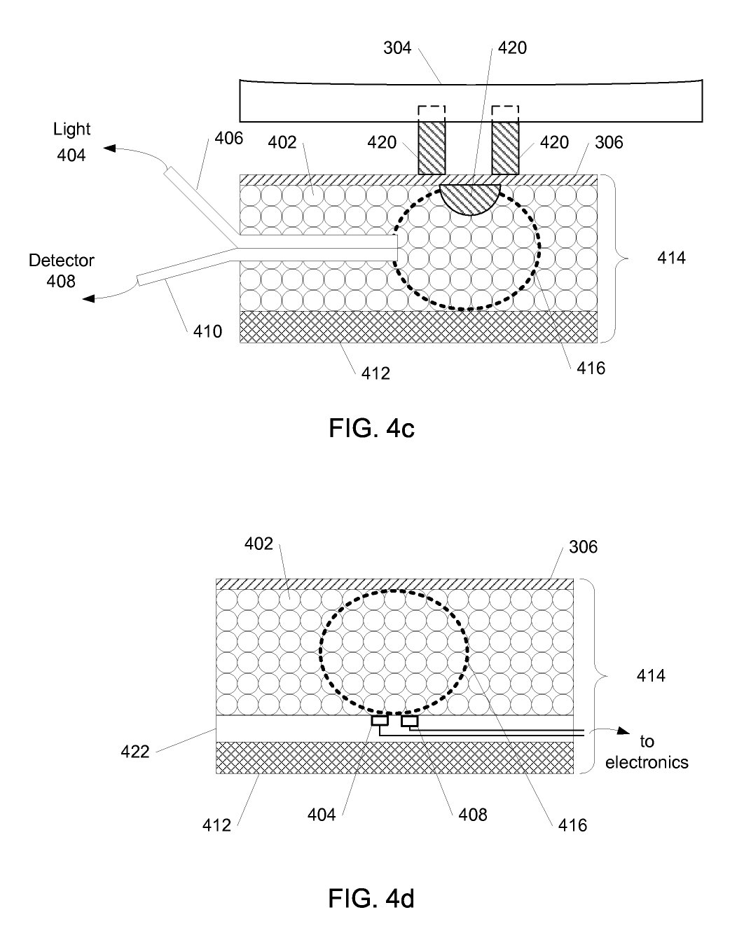

Turning now to embodiments of the present disclosure in FIGS. 3, 4a, 4b, 4c, and 4d, a tactile force sensor stenotype (“tactile steno”) keyboard 300 with tactile force sensors 302 is illustrated. Note that the figures and drawings are not necessarily drawn to scale and certain features have been enlarged or decreased in size for purposes of illustrating features of the present disclosure only. The tactile steno keyboard 300 uses a layout of key positions or a pattern of keys 304 on a keyboard platform 414 that is similar in key size, shape and spacing, to the key layout of the prior art stenography machine of FIG. 1. In one embodiment of the present disclosure, hard keys 304 and a surrounding chassis are integrated with a tactile steno keyboard 300 to present a stenographer the same familiar appearance of a prior art stenography keyboard layout as in FIG. 1. In this embodiment the chassis can be made considerably smaller and more ergonomic than a prior art stenography machine. In the tactile steno keyboard 300, a key position defines the area where sensing of key 304 presses occurs, and in various embodiments a key position smaller than, similarly sized as, or larger than the key 304 it detects. In another embodiments, one or more key positions overlaps an adjacent key position. In most embodiments at least part of a key 304 is discontiguous from adjacent keys 304, for aesthetic as well as mechanical and tactile reasons. In alternate embodiments some or all of the keys 402 are contiguous with adjacent keys 304.

The tactile steno keyboard 300 uses one or more tactile force sensors 302 embedded within the keyboard platform 414 to detect key presses. In one embodiment, the tactile steno keyboard 300 is comprised of a foam pad 402 having a protective membrane 306 on its top surface with the keys 304 detailed, outlined, printed, embedded, or indented on the top surface of the protective membrane 306 and having a mechanical substrate 412, for example a plastic or rigid plate, on its bottom surface for mechanical support. Each key 304 is in communication with one or more tactile force sensors 302. In an alternative embodiment, the keys 304 are physical buttons as in a conventional keyboard.

A tactile force sensor 302 is a compressible foam pad 402 of pressure sensitive material, including but not limited to Kinotex® (Kinotex® is a Registered Trademark of Tactex Controls Inc.). Kinotex® is a commercially available sensor material constructed of an open cell flexible foam comprised of urethane or silicone. Other pressure sensitive materials as would be understood by one of ordinary skill in the art may similarly be utilized. The foam pad 402 scatters or diffuses one or more sources of light 404, e.g., an LED, that are directed into the interior of the foam pad 402. As used herein, the term light is intended to be used broadly to include not only light of a specific frequency in the visible spectrum such as that from an LED, but also include broad spectrum visible light, coherent electromagnetic radiation, UV, IR, or any type of electromagnetic radiation as would be understood by one of ordinary skill in the art.

In the embodiment of FIGS. 4a, 4b, and 4d, the source of light 404 is introduced by one or more input optical fibers 406 into a point within the foam pad 402. Each input optical fiber 406 creates an optical integrating cavity 416 that is the portion of the foam pad 402 illuminated by the source of light 404. The optical integrating cavity 416 is a sensing area that returns sufficient light to a detector 408 to enable detection of key 304 presses. The source of light 404 is directed into the foam pad 402 of the tactile steno keyboard 300 in such as way as to form multiple optical integrating cavities 416 within the foam pad 402. In alternate embodiments, multiple sources of light 404 illuminate the optical integrating cavities 416. In another embodiment, multiple sources of light 404 illuminate each optical integrating cavity 416.

Detectors 408, e.g., photodiodes, are in communication with the optical integrating cavities 416 in the foam pad 402 via output optical fibers 410. The detectors 408 detect changes in light intensity as the optical integrating cavities 416 in the foam pad 402 are deformed. Each optical integrating cavity 416 and associated detector 408 is specifically designed to be able to detect a key press of one of the keys 304 while not being affected by key 304 presses occurring in adjacent keys 304. In alternative embodiments, the sources of light 404 in adjacent cavities use different frequencies to eliminate interference caused by light leaking from one optical integrating cavity 416 into another optical integrating cavity 416.

Referring now to embodiment illustrated by FIG. 4d, the light source 404 and detector 408 reside in an electronics layer 422 and are in direct communication with the optical integrating cavity 416 without requiring the use of optical fibers 406, 410. In an alternate embodiment, the light source 404 and detector 408 extend into the foam pad 402. In alternate embodiments multiple light sources 404 and multiple detectors 408 are used to illuminate each optical integrating cavity 416 and detect returned light.

The tactile force sensor 302 detects when a user has applied a force to a key 304 associated with the tactile force sensor 302. When pressure is applied to the foam pad 402, such as by a user's finger, the individual cells in the foam pad 402 compress and change shape in proportion to the pressure applied. The change in shape of the individual cells in a compressed area 418 causes detectible changes to the scattering and diffusing of the light 404 incident on the foam pad 402 from the input optical fibers 406, thereby modifying the light returned via the output optical fibers 410 and detected by the photo detectors 408. In one embodiment, deforming the foam pad 402 reduces the amount of light returned to the detector 408. In another embodiment, deforming the foam pad 402 increases the amount of light returned to the detector 408. The foam pad 402 in the tactile force sensor 302 allows detection of even minute displacements due to small forces or pressures applied to the foam pad 402. When configured into a key 304, a tactile force sensor 302 is capable of registering key presses that would be missed by mechanical keyboards which require full compression to register key 304 presses. In alternate embodiments, the detectors 408 detect the returned light directly from the optical integrating cavity 416.

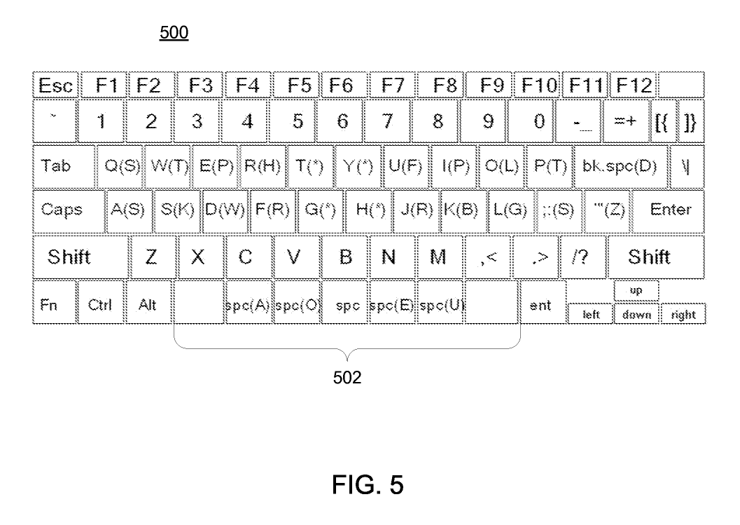

When a user attempts to press two keys simultaneously, as is performed on a stenography machine of FIG. 1, a mechanical keyboard as in FIGS. 2a and 2b, the tactile steno keyboard 300 of FIG. 3, or a hybrid stenotype keyboard 500 of FIG. 5, the user presses at the crack or space between two adjacent keys 304. A prior art mechanical keyboard, as in FIGS. 2a and 2b, requires key travel principally in a vertical direction. When pressing two keys simultaneously on a prior art mechanical keyboard, both keys are required to be pressed fully to register both key presses. However, a finger has more rigidity on the top portion of the finger due to the nail and other bony structures, whereas the bottom of a finger has fleshy padding and therefore compresses more easily. Because of the finger's anatomy and ordinary human inaccuracy during any key press, mechanical keyboards are susceptible of missing a bottom key press when a user attempts to simultaneously press a top and bottom key together. Unlike a mechanical keyboard that requires a key to move a given distance in a vertical direction to register, a tactile force sensor 302 is capable of sensing pressures from both lateral and horizontal directions. A key 304 using a tactile force sensor 302 is therefore capable of registering incomplete or partial key presses as well as glancing key 304 presses that would be missed by a mechanical keyboard.

Turning back to embodiments of the present disclosure in FIGS. 3, 4a, 4b, and 4d, each key 304 comprises one or more tactile force sensors 302. In one embodiment, each key 304 further comprises a protective membrane 306 which focuses the energy and direction of a key press onto one or more tactile force sensors 302 located under the protective membrane 306 in the foam pad 402. Protective membranes 306 improve the sensitivity of the keyboard 300, provide a protective wear layer above the tactile force sensor 302, and allow the tactile force sensors 302 to be configured as a number of individual sensing areas, each such sensing area being an optical integrating cavity 416 associated with a key 304 on a keyboard 300. In various embodiments, the protective membrane 306 is flexible, rigid, semi-rigid, or combinations of different thicknesses and rigidities to provide proper tactile response to the stenographer's key presses or allow suitable force to be applied to the proper sensing area of a tactile force sensor 302. Because the protective membrane 306 is flexible, in some embodiments the keys 304 are not physically disconnected from one another and are visually differentiated from other keys 304 by the printing and detailing of the protective membrane 306, for example using only printed letters and boxes for keys 304.

Referring now to various embodiments illustrated by FIG. 4c, a cap is attached to the protective membranes 306 to form the key 304. The cap is made of a hard material, including but not limited to plastic, and is shaped to appear similar to a keyboard key 304. The cap is adhered to an actuator 420 which focuses pressure onto the optical integrating cavity 416. In another embodiment, the cap is adhered directly to the key 304. In another embodiment, the membrane 306 is connected to one or more actuators 420 which focus pressure from a key press onto appropriate places on the tactile force sensor 302 and the associated optical integrating cavity 416, and provide more sensitive tactile response to the key presses of the stenographer who is using the tactile steno keyboard 300. In another embodiment, the actuators 420 are integrated into the membrane 306, such as harder beads of material embedded into the membrane 306 material. In other embodiments, an actuator 420 is placed on the bottom surface of the membrane 306; in one such embodiment the actuator 420 precompresses the foam pad 402. In yet another embodiment, when the keys 304 are physical buttons, actuators 420 are separate shafts of hard material connecting the key 304 to the membrane 306.

The actuators 420 are optimally placed where the stenographer's fingers are anticipated to strike to enhance the capability of detecting a key press. When the stenographer is striking a key 304 by itself, the stenographer will normally hit the center of the key 304, therefore most keys 304 have an actuator 420 in the center of the key 304. Not every letter or character in the alphabet is represented on a stenograph keypad. Stenographer's encode those missing characters by striking certain key 304 combinations, such as the T and K keys 304 for encoding the letter D, or the P and W keys 304 for encoding B. When the stenographer desires to press two keys 304 together, the stenographer strikes approximately at the crack or space between the two adjacent keys 304, thereby striking both keys 304. Therefore, each of those key 304 pairs in the tactile steno keyboard 300 also have actuators 420 near the cracks between the keys 304, and not just centrally located under a key 304. Also, the larger keys 304 in the middle and sides of the tactile steno keyboard 300 have one or more additional actuators 420 to help ensure that each key press is detected on these larger keys 304, even if the key 304 is struck off center.

In an alternate embodiment, the sources of light 404 and detectors 408 are located some distance from the keyboard platform 414 and use optical fibers to both send, via input optical fibers 406, and receive, via output optical fibers 410, light to and from the foam pad 402 of the keyboard platform 414. In these embodiments, the keyboard 300 has only mechanical and optical components, thus isolating it electrically and making the keyboard 300 suitable for environments where such electrical isolation is advantageous. Additionally, the lack of electrical components allows the keyboard 300 to be of lighter weight, more flexible, more durable, and generate negligible amounts of heat when compared with a conventional keyboard that contains both mechanical and electrical components.

The passive opto-mechanical part of the tactile steno keyboard 300 does not require power, allowing the circuitry that drives the light source 404 and detectors 408 to be extremely low power. To further save on power, the source of light 404 is pulsed rather than continuously driven. The low power features of the tactile steno keyboard 300 make it practical for it to be battery operated although it can be driven by the peripheral port on the computer to which it is connected, including but not limited to a USB port.

When a key 304 is pressed, the change in light detected by the detector 408 is converted into an electrical signal that is conditioned by electronics circuitry. The electronics circuitry debounces the signal, analyzes characteristics of the detected change in the light received such as rate of change characteristics, and performs intelligent thresholding to detect which keys 304 have been pressed. The electronics circuitry then interprets and converts the detected user's key presses into one or more keystrokes that are forwarded to a computer. Because the tactile steno keyboard 300 uses tactile force sensors, and not contact type sensors, sensitivity to key presses can be adjusted. In alternative embodiments, software residing on in the tactile steno keyboard 300 or a separate computing device performs the functions of the electronics circuitry. In further embodiments, the tactile steno keyboard 300 has internal memory for storing key presses and interpreted keystrokes, allowing it to remain disconnected from the computer for a period of time and then reconnected to a serial port in order to output or download the stored key presses and keystrokes. Alternatively, the tactile steno keyboard 300 has a wireless connection port, for example Bluetooth, Wifi, or InfraRed, to forward the key presses or interpreted keystrokes to a remote computer. In another embodiment, the memory is removable and the key presses and keystrokes can be retrieved by inserting the memory into a computing device. In still other embodiments, the tactile steno keyboard 300 has voice recording capabilities and voice-to-data translation capabilities.

Hybrid Stenotype Keyboard

Referring now to an embodiment of a hybrid stenotype keyboard 500 in FIG. 5, the key functions of a conventional stenotype input device overlap key functions of a computer keyboard layout. Specifically, some of the keys on a Qwerty keyboard (FIG. 2a) are remapped to the stenotype keys (FIG. 1), where the letters in parentheses indicate the mapped stenograph keys. The hybrid stenotype keyboard 500 functions in both a conventional computer keyboard mode, e.g., a Qwerty keyboard, as well as a conventional stenotype keyboard mode. A user is able to switch automatically, even between keystrokes, from one type of keyboard mode to the other. In operation, the hybrid stenotype keyboard 500 seamlessly changes from a conventional computer, Qwerty, keyboard (Qwerty-mode) to a stenograph keyboard (Stenotype-mode) wherein the computer keys are mapped to behave functionally like the stenograph keys. In an alternate mode, the hybrid stenotype keyboard 500 supports Dvorak and alternate computer keyboard layouts.

Because the Qwerty keyboard has more keys than the stenograph keypad, some Qwerty keys on the hybrid stenotype keyboard 500 are not remapped. In one embodiment, the unmapped keys are disabled, so that pressing them will not result in any keystroke being registered. In other embodiments, the unmapped keys continue to function as the keystrokes indicated on the face of the keys. A given key position can be either a Qwerty key or a Stenotype key depending on which mode the hybrid stenotype keyboard 500 is in.

Because the hybrid stenotype keyboard 500 uses tactile force sensors, and not contact type sensors, sensitivity to key presses can be configurable which permits fine tuning of the hybrid stenotype keyboard 500 depending upon whether it is in Qwerty-mode and Stenotype-mode. This allows for a different keyboard response for stenography than computer typing.

In one embodiment, to switch between Qwerty-mode and Stenotype-mode, the Caps key, also known as the Caps Lock key, is used. The Caps key is used for convenience purpose only, and in other embodiments, a different key, or key combination of 2 or more keys, is used to set the keyboard mode. For example, any of the Function Keys can be used, or a Control-Alt sequence, such as Control-Alt-Z. In yet other embodiments, a single keystroke may switch the keyboard between modes or a single key pressed two or more times in sequence, e.g., the Caps Lock key pressed twice, switches the mode of the keyboard 500. In one embodiment, switching the keyboard mode is implemented on the keyboard 500 itself, with a separate dedicated key or switch. In an alternate embodiment, the keyboard mode selection is controlled by software residing on the attached computer.

The spacebar 502 on computer keyboards is typically one long contiguous key. By dividing the spacebar into multiple keys, shown in FIG. 5, the keyboard's 500 A, O, E and U keys are placed where stenographers are accustomed to striking them, thus providing similar key placement as a stenography machine. When the keyboard 500 is in Qwerty-mode, any of the individual keys comprising a conventional spacebar work as the spacebar 502 allowing a computer user to continue striking a spacebar key in the places the user is accustomed to. In this embodiment, the individual keys comprising the spacebar 502 are sized similar to the other keys. In an alternate embodiment, they keys are larger, non-rectangular or even non-uniform dimensions to facilitate ease of use for either the typist or stenographer.

In one embodiment, the hybrid stenotype keyboard 500 is a modified computer keyboard and connects directly to a PC or laptop. In alternative embodiments, the size, shape, and spacing of the keys 304 is similar to a conventional computer keyboard. In other embodiments, the keys are sized larger, smaller, or of different sizes, and are closer together similar to a prior art stenography machine. In another embodiment, the hybrid stenotype keyboard 500 is similar to a tactile steno keyboard 300 and the keys 304 are soft keys detailed on the top surface of a protective membrane 306 as in FIG. 4a, 4b or 4d. In another embodiment, the keys 304 have hard caps as shown on FIG. 4c.

### CONCLUSION

The tactile steno keyboard 300 is an inexpensive, lightweight stenography keypad that is easily transported, set up, and used in a small footprint, for example on a stenographer's lap, while still maintaining the characteristic layout and tactile response of a conventional stenography machine. The hybrid stenotype keyboard 500 allows a stenographer to quickly switch between using the hybrid stenotype keyboard 500 as a conventional computer style input keyboard with a Qwerty layout and as a stenotype style input keyboard without physically having to switch from one physical input device to another.

While various embodiments have been described above, it should be understood that the embodiments have been presented by way of example only, and not limitation. It will be understood by those skilled in the art that various changes in form and details may be made therein without departing from the spirit and scope of the subject matter described herein and defined in the appended claims. Thus, the breadth and scope of the present invention should not be limited by any of the above-described exemplary embodiments, but should be defined only in accordance with the following claims and their equivalents.

We claim:

1. A keyboard comprising:
a plurality of key positions defining a stenotype keyboard, each key position comprising at least one region of a pressure sensitive material, said pressure sensitive material being responsive to lateral and horizontal pressures;
a means for determining if a contact of one or more of said key positions occurs by measuring an applied pressure on said at least one region of said pressure sensitive material;
a means for interpreting said contact of one or more of said key positions into one or more interpreted keystrokes; and
a means for outputting said interpreted keystrokes.

2. The keyboard of claim 1, wherein said pressure sensitive material, in response to said applied pressure, produces a detectible change in an electromagnetic radiation in said pressure sensitive material and wherein said means for determining said contact of one or more of said key positions requires a minimum detectible change be met.

3. The keyboard of claim 2, further comprising a means for adjusting said minimum detectible change.

4. The keyboard of claim 2, wherein said means for determining further comprises a means for transmitting said electromagnetic radiation to said pressure sensitive material and a means for receiving said electromagnetic radiation from said pressure sensitive material.

5. The keyboard of claim 1, wherein said pressure sensitive material comprises an open cell compressible foam.

6. The keyboard of claim 2, further comprising a plurality of actuators, each of said actuators associated with one of said key positions and focusing said applied pressure of one of said key positions to at least one of said regions of said pressure sensitive material.

7. A keyboard comprising:
a plurality of key positions defining a stenotype keyboard and a computer keyboard, said computer keyboard substantially overlapping said stenotype keyboard;
a means for selecting a mode for the keyboard, wherein said mode is a stenotype keyboard mode or a computer keyboard mode;
a means for determining a contact of one or more of said key positions;
a means for interpreting said contact of one or more of said key positions into one or more interpreted keystrokes based on said mode; and
a means for outputting said interpreted keystrokes.

8. The keyboard of claim 7, wherein said computer keyboard mode is selected from the group consisting of: a Qwerty keyboard layout, and a Dvorak keyboard layout.

9. The keyboard of claim 7, wherein each of said key positions comprises at least one region of a pressure sensitive material responsive to lateral and horizontal pressures.

10. The keyboard of claim 9, wherein said pressure sensitive material responds to an applied pressure to produce a detectible change in an electromagnetic radiation in said pressure sensitive material. and wherein said means of determining if a user of the keyboard contacts one or more of said key positions requires at least a threshold detectible change be met.

11. The keyboard of claim 10, wherein said means for determining said contact requires a minimum detectible change in said electromagnetic radiation.

12. The keyboard of claim 11, further comprising a means for adjusting said minimum detectible change to a user selected value.

13. The keyboard of claim 10, wherein said means for determining further comprises a means for transmitting said electromagnetic radiation to said pressure sensitive material and a means for receiving said detectible change in said electromagnetic radiation from said pressure sensitive material.

14. The keyboard of claim 9, wherein said pressure sensitive material comprises an open cell compressible foam.

15. The keyboard of claim 7, further comprising a plurality of keys, each of said keys associated with one of said key positions and focusing said contact to at least one region of said pressure sensitive material.

16. The keyboard of claim 15, further comprising a rigid structure selected from the group consisting of a cap adhered to one of said keys, an actuator associated with one of said keys, an actuator associated with one of said key positions, and a cap adhered to an actuator that is associated with one of said key positions.

17. A method of detecting keystrokes on a keyboard, comprising:
illuminating a region of a compressible foam;
accepting a key press from the keyboard, said key press compressing said region of said compressible foam and creating a detectible change in a returned illumination;
sensing said detectible change in said returned illumination; and
interpreting said detectible change into a keystroke.

18. The method of claim 17, further comprising storing said keystroke in a memory.

19. The method of claim 17, further comprising outputting said keystroke.

20. The method of claim 19, wherein said outputting is performed using a transmission protocol selected from the group consisting of a fiberoptic communication, a serial communication, a USB communication, a wireless communication.
